(19) United States
(12) Patent Application Publication
(10) Pub. No.: US 2025/0206346 A1
(43) Pub. Date: Jun. 26, 2025

(54) DEVICE AND SYSTEM FOR CONTROLLING THE SPEED OF AUTONOMOUS VEHICLE

(71) Applicant: HL KLEMOVE CORPORATION, Incheon (KR)

(72) Inventors: Chang-Won KIM, Incheon (KR); Dae-Youn YUN, Incheon (KR); Ye-Chan JANG, Incheon (KR)

(21) Appl. No.: 18/924,771

(22) Filed: Oct. 23, 2024

(30) Foreign Application Priority Data
Dec. 22, 2023 (KR) 10-2023-0189802
May 28, 2024 (KR) 10-2024-0069192

(51) Int. Cl. B60W 60/00

(52) U.S. Cl. CPC B60W 60/0015; B60W 2420/408; B60W 2554/4041; B60W 2554/802; B60W 2556/45; B60W 2720/10

(57) ABSTRACT

The present disclosure provides device for controlling a speed of an autonomous vehicle using a portable radar provided in a target object, the device including a receiver for receiving radar information of a portable radar, a process configured to determine whether a target object is located in the vicinity of an autonomous vehicle based on the radar information, and a controller configured to reduce a speed of the autonomous vehicle or stop the autonomous vehicle based on the target object being located in the vicinity of the autonomous vehicle.

### CROSS-REFERENCE TO RELATED APPLICATION

This application claims priority to and the benefit from Korean Patent Application No. 10-2023-0189802, filed on Dec. 22, 2023, and No. 10-2024-0069192, filed on May 28, 2024, the disclosures of which are incorporated herein by reference in their entirety.

### BACKGROUND

### Technical Field

The present disclosure relates to a device and system for controlling a speed of an autonomous vehicle.

### Discussion of Related Art

In the case of a roadway having a narrow road width or a narrow backroad without distinction between a roadway and a sidewalk, it is difficult to install traffic lights due to road conditions, and vehicles are often parked at the edge of the roadway, and even where there is no crosswalk, pedestrians frequently cross the roadway between cars parked on the edge.

Due to these road conditions, a lot of cross-road traffic safety accidents are occurring, and in particular, school zone traffic safety accidents in front of the school are emerging as social problems, so solutions are urgently required, but clear solutions are not presented.

The development of technology (e.g., sensor technology, radar technology, and the like), such as sensing and detecting the environment around the road on which the vehicle travels, and the driving situation of the vehicle, has been carried out to develop technology for autonomous vehicles.

Recently, autonomous vehicles with a low-level (low-level of autonomous driving technology for autonomous driving of vehicles) or a mid-level (mid-level of autonomous driving technology for autonomous driving of vehicles) have been developed, and driving tests on actual roads have been conducted everywhere, and in particular, actual operation of autonomous vehicles is being attempted in some areas (e.g., internal driving roads in university campuses, internal driving roads inside amusement parks, etc.) where a driving area is limited.

Autonomous vehicles may sense (detect) moving objects (e.g., a vehicle, a bicycle, bike, an animal, a person, etc.) that approach from the front, sides, and rear, etc. through a sensor and a radar, etc. mounted at predetermined positions of the vehicle.

That is, autonomous vehicles may perform autonomous driving control such as collision avoidance driving and vehicle stopping by detecting the approach of the moving object, thereby preventing an accident such as collision of the autonomous vehicle with the moving object.

Meanwhile, the sensors mounted on autonomous vehicles have limitations in detecting target objects (e.g., a child and a pet, etc.) that are small in size and slow in speed, or have limited detecting areas of the sensors due to environmental variables (e.g., rain, snow, fog, etc.).

Accordingly, there is a problem in that the risk of the accident is high when autonomous vehicles are autonomously driven depending on the sensors.

### BRIEF SUMMARY

In order to solve the above problems, the present disclosure provides a device and system for controlling a speed of an autonomous vehicle capable overcoming the limitations of sensors mounted on the autonomous vehicle by reducing the speed of the autonomous vehicle or stopping the autonomous vehicle when the target object is close to the autonomous vehicle using a portable radar mounted on the target object.

In addition, the present disclosure aims to provide a device and system for controlling a speed of an autonomous vehicle capable of reducing the possibility of the accident and improving the driving stability of the autonomous vehicle by flexibly adjusting a reference distance according to a road situation on which the autonomous vehicle travels, an environment situation, and a kind of the object.

In addition, the present disclosure aims to provide a device and system for controlling a speed of an autonomous vehicle capable of further extending the lifetime of the battery operating the portable radar.

The technical problems of the present disclosure are not limited to the above-mentioned technical problems, and other technical problems not mentioned herein may be clearly understood by those skilled in the art from the following description.

In order to solve the above problems, the present disclosure provides a speed control device of an autonomous vehicle using a portable radar provided in a target object, the device comprising a receiver configured to receive radar information of a portable radar; a process configured to determine whether a target object is located in the vicinity of an autonomous vehicle based on the radar information; and a controller configured to reduce a speed of the autonomous vehicle or stop the autonomous vehicle based on the target object being located in the vicinity of the autonomous vehicle.
the radar information may include object information and location information of the target object.
the processor may calculate a distance between the autonomous vehicle and the target object based on the locations of the autonomous vehicle and the target object.
In addition, the controller may reduce the speed of the autonomous vehicle or stop the autonomous vehicle based on the distance between the autonomous vehicle and the target object being less than a reference distance.

In addition, the processor may vary the reference distance depending on an area in which the autonomous vehicle is located.

In addition, the present disclosure provides a speed control device of an autonomous vehicle using a portable radar provided in a target object, the system including a portable radar configured to transmit radar information; a router configured to transmit the radar information received from the portable radar to an autonomous vehicle; and a speed controller configured to determine whether a target object is located in the vicinity of the autonomous vehicle based on the radar information received from the router and reducing a speed of the autonomous vehicle or stop the autonomous vehicle based on the target object being located in the vicinity of the autonomous vehicle.
the radar information may include object information and location information of the target object.
the portable radar may periodically transmit the radar information to the router.
the router may be allocated to each of a plurality of areas and receive the radar information from the portable radar based on the location of the target object in the allocated area.
the router may share the radar information received from the portable radar with neighboring routers.
the router may transmit the radar information to the autonomous vehicle based on the location of the autonomous vehicle in the allocated area.
the portable radar may vary a transmission period of the radar information depending on an area in which the target object is located.
the speed controller may calculate a distance between the autonomous vehicle and the target object based on the locations of the autonomous vehicle and the target object.

In addition, the speed controller may reduce the speed of the autonomous vehicle or stop the autonomous vehicle based on the distance between the autonomous vehicle and the target object being less than a reference distance.

In addition, the speed controller may vary the reference distance depending on an area in which the autonomous vehicle is located.

According to the present disclosure, the limitations of sensors mounted on the autonomous vehicle may be overcome by determining the position of the target object using the portable radar mounted on the target object, and reducing the speed of the autonomous vehicle or stopping the autonomous vehicle when the target object is close to the autonomous vehicle.

In addition, according to the present disclosure, by flexibly adjusting the reference distance according to the road situation on which the autonomous vehicle travels, an environment situation, and a kind of the object, thereby reducing the possibility of the accident and improving the driving stability of the autonomous vehicle

In addition, according to the present disclosure, when the target object is located in an area a lot of vehicle movement, the transmission period of radar information may be set shorter to more reliably protect the target object from the risk of accidents, and on the contrary, when the target object is located in an area with little vehicle movement, the transmission period of radar information may be set longer to further increase the lifetime of the battery for operating the portable radar.

The effects of the present disclosure are not limited to the above effects, and it should be understood that they include all effects that can be inferred from the detailed description of the present disclosure or the composition of the disclosure described in the claims.

### BRIEF DESCRIPTION OF THE SEVERAL VIEWS OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a speed control system of an autonomous vehicle according to an embodiment of the present disclosure.

FIG. 2 is a diagram for illustrating an operation of a speed control system of an autonomous vehicle according to an embodiment of the present disclosure.

FIG. 3 is a diagram for illustrating a ZigBee communication network used in a speed control system of an autonomous vehicle according to an embodiment of the present disclosure.

FIG. 4 is a block diagram for illustrating an operation of a speed control device of an autonomous vehicle according to an embodiment of the present disclosure.

FIG. 5 is a block diagram of a speed control device of an autonomous vehicle according to an embodiment of the present disclosure.

FIG. 6 is a block diagram of a portable radar according to an embodiment of the present disclosure.

FIG. 7 is a flowchart of a method of controlling a speed of an autonomous vehicle according to an embodiment of the present disclosure.

### DETAILED DESCRIPTION

Hereinafter, embodiments of the present disclosure are described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as a meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and not preclude the possibility of the presence or addition of one or more other features, numbers, steps, operations, components, parts, or combinations thereof.

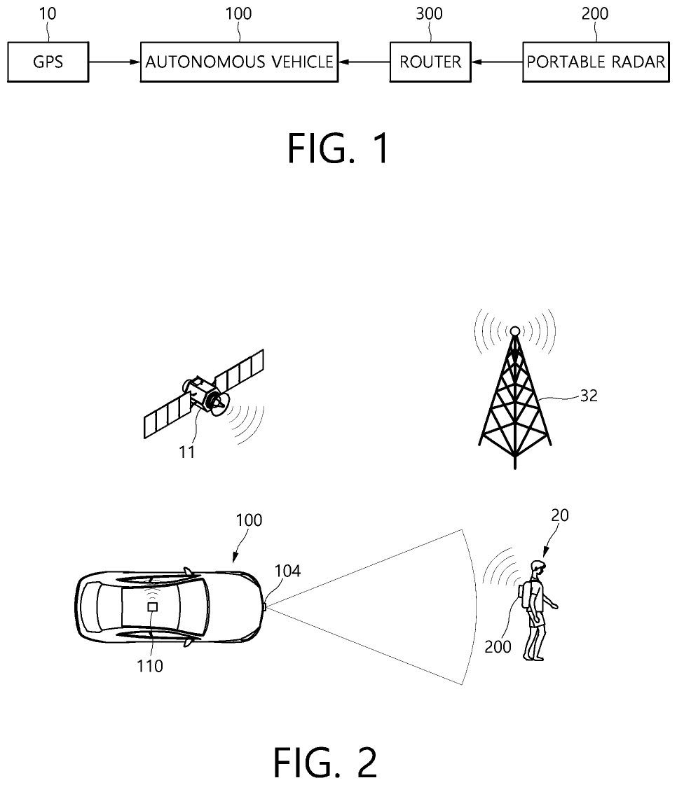

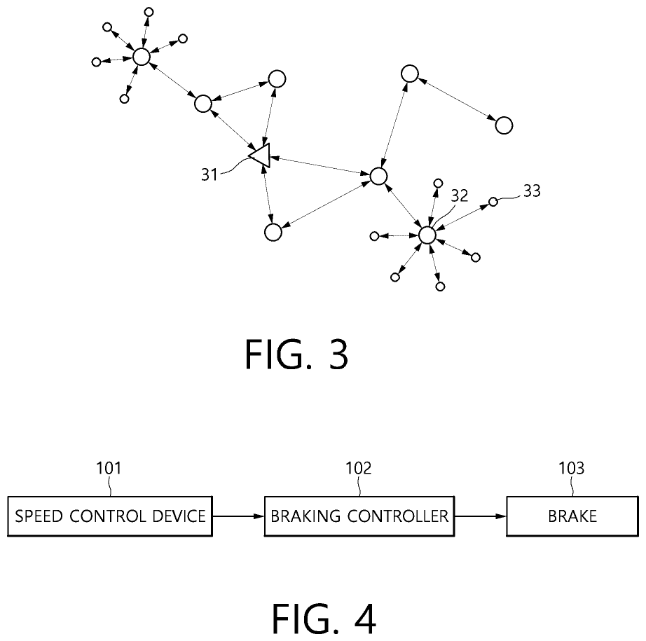

FIG. 1 is a block diagram of a speed control system of an autonomous vehicle according to an embodiment of the present disclosure, FIG. 2 is a diagram for explaining the operation of the speed control system of an autonomous vehicle according to an embodiment of the present disclosure, and FIG. 3 is a diagram illustrating a ZigBee communication network used in the speed control system of an autonomous vehicle according to an embodiment of the present disclosure.

As shown in FIG. 1, the speed control system of an autonomous vehicle according to an embodiment of the present disclosure may include a Global Positioning System (GPS) 10, an autonomous vehicle 100, a router 32, and a portable radar 200.

As shown in FIG. 2, the autonomous vehicle 100 may be equipped with a receiver 110 and a sensor 104.

Here, the sensor 104 may detect other vehicles, pedestrians, obstacles, and lanes, and the like in the vicinity of the autonomous vehicle 100.

In FIG. 2, although the sensor 104 is shown as being mounted in front of the autonomous vehicle 100, but the sensor 104 is not limited thereto and may be mounted in the rear and sides of the autonomous vehicle 100.

The sensor 104 may include a camera, radar, lidar, and ultrasonic sensor.

The receiver 110 may receive a GPS signal from a Global Positioning System (GPS) satellite.

The autonomous vehicle 100 may determine a location of the autonomous vehicle 100 using the GPS signal received by the receiver 110, and may determine a surrounding situation of the autonomous vehicle 100 recognized by the sensor 104 to perform autonomous driving.

Meanwhile, the sensor 104 mounted on the autonomous vehicle 100 has limitations in detecting a target object (e.g. a child, a pet, etc.) 20 that is small in size or slow in speed or has a limited detection area of the sensor 104 due to environmental variables (e.g. rain, snow and fog, etc.).

Accordingly, when the autonomous vehicle 100 drives autonomously depending on the sensor 104, the risk of an accident is high.

To solve this problem, the present disclosure may determine the location of the target object 20 using the portable radar 200 mounted on the target object 20, and reduce the speed of the autonomous vehicle 100 or stop the autonomous vehicle 100 when the target object 20 is close to the autonomous vehicle 100, thereby overcoming the limitations of the sensor 104 mounted on the autonomous vehicle 100.

The portable radar 200 is a device carried by the target object 20 and may be mounted on the rear of the target object 20, and is a device that detects a moving object (e.g., a vehicle, a bicycle, etc.) located behind the target object 20 and outputs an alarm when the moving object approaches the target object 20 and there is a risk of collision.

As described above, the portable radar 200 may protect the target object 20 by allowing the target object 20 to avoid the moving object by outputting the alarm when the moving object approaches the target object 20.

The portable radar 200 may communicate with the autonomous vehicle 100 using a ZigBee communication network. However, the present disclosure is not limited thereto and may communicate with the autonomous vehicle 100 using various communication networks.

Here, the ZigBee is a low-power wireless communication protocol and is mainly used in a field that requires simple data transmission and requires long battery life and security.

As shown in FIG. 3, the ZigBee communication network may include a ZigBee coordinator 31, a ZigBee router 32, and a ZigBee end device 33. Here, the ZigBee coordinator 31 serves to form a ZigBee network and connect other networks, and may exist one for each network. The ZigBee router 32 performs an application function and performs a function of transmitting data from other devices. In addition, the ZigBee end device 33 performs a function that may communicate with the parent node, and this relationship allows the node to wait for a long time, thereby extending the battery life longer.

Referring again to FIG. 2, the portable radar 20 periodically transmits radar information (e.g., object information and location information of the target object 20) to the ZigBee router 32, and the ZigBee router 32 transmits the radar information received from the portable radar 20 to the autonomous vehicle 100.

Accordingly, the autonomous vehicle 100 may determine the target object 20 located in the vicinity of the autonomous vehicle 100 using the radar information received through the ZigBee router 32 to reduce the speed of the autonomous vehicle 100 or stop the autonomous vehicle 100.

The ZigBee router 32 is allocated to each of a plurality of areas and may receive the radar information from the portable radar 200 based on the location of the target object 20 in the allocated area.

The ZigBee router 32 may share the radar information received from the portable radar 200 with neighboring routers.

Specifically, the ZigBee router 32 may integrate the radar information received from the portable radar 200 and the radar information received from the other ZigBee routers 32.

The ZigBee router 32 may transmit the radar information to the autonomous vehicle 100 based on the position of the autonomous vehicle 100 in the allocated area.

Here, the ZigBee router 32 may integrate the radar information received from the portable radar 200 and the radar information received from the other ZigBee routers 32 and transmit the same to the autonomous vehicle 100.

Accordingly, the autonomous vehicle 100 may detect and continuously track the moving target object 20 in a wide range.

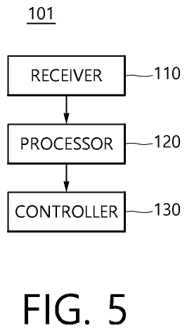

FIG. 4 is a block diagram for illustrating an operation of a speed control device of an autonomous vehicle according to an embodiment of the present disclosure, and FIG. 5 is a block diagram of a speed control device of an autonomous vehicle according to an embodiment of the present disclosure.

Referring to FIG. 4, the autonomous vehicle 100 may include a speed control device 101, a braking controller 102, and a brake 103.

The speed control device 101 may determine whether the target object 20 is located in the vicinity of the autonomous vehicle 100 based on the GPS signal received by the receiver 110 and the radar information of the portable radar 200 and the surrounding situation of the autonomous vehicle 100 recognized by the sensor 104, and may transmit a deceleration control signal or a braking control signal to the braking controller 102 when the target object 20 is located in the vicinity of the autonomous vehicle 100.

Accordingly, the braking controller 102 may control the brake 103 based on the deceleration control signal or the braking control signal received from the speed control device 101.

Referring to FIG. 5, the speed control device 101 is a speed control device of the autonomous vehicle 100 using the portable radar 200 mounted on the target object 20, and may include a receiver 110, a processor 120, and a controller 130.

The receiver 110 receives a GPS signal from a GPS satellite 11 and receives the radar information of the portable radar 200 through the ZigBee router 32. Here, the radar information may include object information and location information of the target object 20.

The receiver 110 may be configured as one or may be configured in two to receive each of the GPS signal and the radar information.

The processor 120 may determine whether the target object 20 is located in the vicinity of the autonomous vehicle 100 based on the radar information received from the receiver 110.

The controller 130 may reduce the speed of the autonomous vehicle 100 or stop the autonomous vehicle 100 based on the target object 20 being located in the vicinity of the autonomous vehicle 100.

The processor 120 may calculate a distance between the autonomous vehicle 100 and the target object 20 based on the locations of the autonomous vehicle 100 and the target object 20.

Here, the processor 120 determines the location of the autonomous vehicle 100 based on the GPS signal received from the GPS satellite 11, and determines the location of the target object 20 based on the location information of the target object 20 received from the router 32.

In addition, the processor 120 may determine a moving direction and a relative speed of the target object 20, and an approach of the target object 20 to the autonomous vehicle 100 based on the locations of the autonomous vehicle 100 and the target object 20.

The controller 130 may reduce the speed of the autonomous vehicle 100 based on the distance between the autonomous vehicle 100 and the target object 20 being less than the first reference distance. That is, the controller 130 transmits the deceleration control signal to the braking controller 102 based on the distance between the autonomous vehicle 100 and the target object 20 being less than the first reference distance. Then, the braking controller 102 controls the brake 103 according to the deceleration control signal.

The controller 130 may stop the autonomous vehicle 100 based on the distance between the autonomous vehicle 100 and the target object 20 being less than the second reference distance smaller than the first reference distance. That is, the controller 130 transmits the braking control signal to the braking controller 102 based on the distance between the autonomous vehicle 100 and the target object 20 being less than the second reference distance. Then, the braking controller 102 controls the brake 103 according to the braking control signal.

The controller 130 may reduce the speed of the autonomous vehicle 100 or stop the autonomous vehicle 100 in consideration of the moving direction and the relative speed of the target object 20, and the approach of the target object 20 to the autonomous vehicle 100.

Specifically, even if the distance between the autonomous vehicle 100 and the target object 20 is less than the first reference distance or the second reference distance, the controller 130 may not reduce the speed of the autonomous vehicle 100 or may not stop the autonomous vehicle 100 when the autonomous vehicle 100 does not have a possibility of collision with the target object 20 in consideration of the moving direction and the relative speed of the target object 20, and the approach of the target object 20 to the autonomous vehicle 100.

The processor 120 may vary the first reference distance and the second reference distance depending on the area in which the autonomous vehicle 100 is located.

For example, the processor 120 may increase the first reference distance and the second reference distance when the autonomous vehicle 100 travels on a narrow backroad or school zone without distinction between a roadway and a sidewalk, and on the contrary, may reduce the first reference distance and the second reference distance when the autonomous vehicle 100 travels on a car-only road.

Accordingly, the speed control device of the autonomous vehicle of the present disclosure may flexibly adjust the first reference distance and the second reference distance according to the road situation on which the autonomous vehicle 100 travels, thereby reducing the possibility of accidents and improving the driving stability of the autonomous vehicle 100.

The processor 120 may vary the first reference distance and the second reference distance depending on the environmental variables.

For example, the processor 120 may increase the first reference distance and the second reference distance when the detecting area of the sensor 104 is limited due to rain, snow, fog, and the like, and on the contrary, may reduce the first reference distance and the second reference distance when the detecting area of the sensor 104 is not limited due to clear weather.

Accordingly, the speed control device of the autonomous vehicle of the present disclosure may elastically adjust the first reference distance and the second reference distance according to the environmental situation in which the autonomous vehicle 100 travels, thereby reducing the possibility of accidents and improving the driving stability of the autonomous vehicle 100.

The processor 120 may vary the first reference distance and the second reference distance according to the object information of the target object 20 received from the ZigBee router 32.

For example, the processor 120 may increase the first reference distance and the second reference distance when the target object 20 is a child or a pet, and on the contrary, may decrease the first reference distance and the second reference distance when the target object 20 is an adult.

Accordingly, the speed control device of the autonomous vehicle of the present disclosure may flexibly adjust the first reference distance and the second reference distance according to the type of the target object 20, thereby reducing the possibility of accidents and improving the driving stability of the autonomous vehicle 100.

The processor 120 may determine the number of target objects 20 on the current driving path based on the object information of the target object 20 received from the ZigBee router 32, and may change the driving path according to the number of target objects 20.

For example, when the number of target objects 20 on the current driving path is greater than or equal to a reference number, the processor 120 may reduce the speed of the autonomous vehicle 100 or may change to another driving path without stopping the autonomous vehicle 100.

Here, the processor 120 may compare the time it takes to reach the destination when the autonomous vehicle is decelerated and the time it takes to reach the destination when the driving path is changed, and may select a case that takes less time.

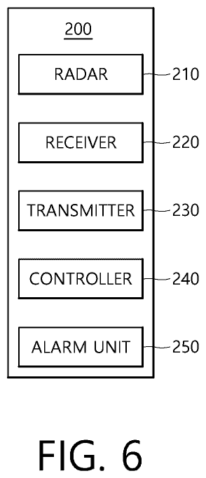

FIG. 6 is a block diagram of a portable radar according to an embodiment of the present disclosure.

As shown in FIG. 6, the portable radar 200 according to the embodiment of the present disclosure may include a radar 210, a receiver 220, a transmitter 230, a controller 240, and an alarm unit 250.

The radar 210 may include a transmitting antenna that radiates a transmission radio wave toward the rear of the target object 20 and a receiving antenna that receives a reflected radio wave reflected to the moving object by the rear side of the target object 20.

The receiver 220 may receive a GPS signal from the GPS satellite 11.

The transmitter 230 periodically transmits radar information about the portable radar 200 (e.g., object information and location information of the target object 20) to the ZigBee router 32.

Here, the transmitter 230 transmits the radar information to a ZigBee router 32 allocated to the predetermined area based on the location of the predetermined area.

Meanwhile, since the portable radar 200 is carried by the target object 20, it is preferable to manufacture it in a small size, and in this case, the battery for operating the portable radar 200 is also manufactured in a small size. Accordingly, there is a limitation on the capacity of the battery.

Here, the transmitter 230 has the advantage of extending the life of the battery by periodically transmitting radar information to the ZigBee router 32 rather than constantly.

The controller 240 is configured to control the radar 210, the receiver 220, the transmitter 230, and the alarm unit 250 to calculate a relative distance between the target object 20 and the moving object based on a phase difference or a time difference between the transmitted radio wave and the reflected radio wave, and to calculate a relative velocity between the target object 20 and the moving object based on a frequency difference between the transmitted radio wave and the reflected radio wave.

In addition, the controller 240 may transmit an alarm output signal to the alarm unit 250 based on the distance between the target object 20 and the moving object being less than the reference distance.

When the alarm unit 250 receives an alarm output signal from the controller 240, the alarm unit 250 may provide an audible or tactile alarm to the target object 20.

As described above, the portable radar 200 may protect the target object 20 by allowing the target object 20 to avoid the moving object by outputting an alarm when the moving object approaches the target object 20.

The controller 240 may determine the location of the target object 20 based on the GPS signal received by the receiver 220.

Accordingly, the controller 240 may vary the transmission period of the radar information depending on the area where the target object 20 is located.

Specifically, when the target object 20 is located in an area a lot of vehicle movement, the controller 240 may set the transmission period shorter to more reliably protect the target object 20 from the risk of accidents, and on the contrary, when the target object 20 is located in an area with little vehicle movement, the controller 240 may set the transmission period longer to further increase the lifetime of the battery.

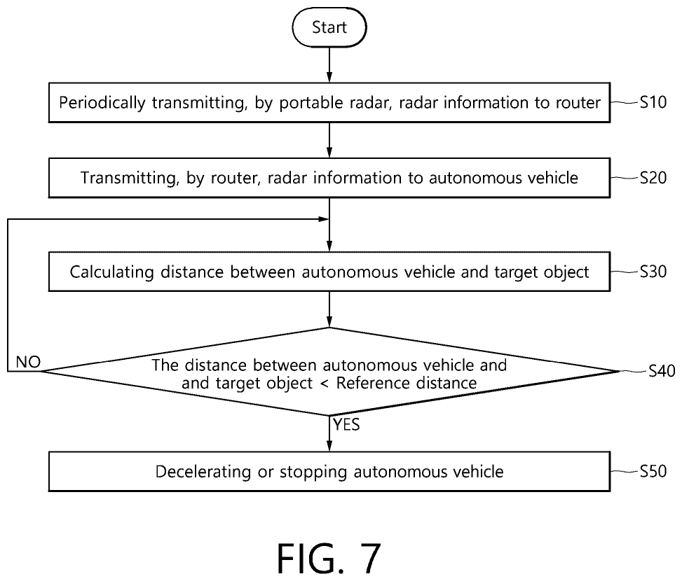

FIG. 7 is a flowchart of a method of controlling a speed of an autonomous vehicle according to an embodiment of the present disclosure.

Hereinafter, the method for controlling the speed of the autonomous vehicle according to an embodiment of the present disclosure will be described with reference to FIG. 7, but the same contents as those described above will be omitted.

The method for controlling the speed of the autonomous vehicle 100 according to the embodiment of the present disclosure first include transmitting radar information (e.g., object information and location information of the target object 20) to the ZigBee router 32 periodically by the portable radar 200 mounted on the target object 20 (step S10).

Here, the ZigBee router 32 may be allocated to each of a plurality of areas and may receive the radar information from the portable radar 200 based on the location of the target object 20 in the allocated area.

The ZigBee router 32 may share the radar information received from the portable radar 200 with neighboring routers.

Specifically, the ZigBee router 32 may integrate the radar information received from the portable radar 200 and the radar information received from the other ZigBee routers 32.

In addition, the portable radar 200 may vary the transmission period of the radar information depending on the area where the target object 20 is located.

Specifically, when the target object 20 is located in an area a lot of vehicle movement, the portable radar 200 may set the transmission period shorter to more reliably protect the target object 20 from the risk of accidents, and on the contrary, when the target object 20 is located in an area with little vehicle movement, the portable radar 200 may set the transmission period longer to further increase the lifetime of the battery.

Next, the ZigBee router 32 transmits the radar information received from the portable radar 200 to the autonomous vehicle (step S20).

Here, The ZigBee router 32 may transmit the radar information to the autonomous vehicle 100 based on the location of the autonomous vehicle 100 in the allocated area.

Next, a distance between the autonomous vehicle 100 and the target object 20 is calculated (step S30).

Here, the location of the autonomous vehicle 100 is determined based on the GPS signal received from the GPS satellite 11, and the location of the target object 20 is determined based on the location information of the target object 20 received from the router 32.

In addition, it may be possible to determine a moving direction and a relative speed of the target object 20, and an approach of the target object 20 to the autonomous vehicle 100 based on the locations of the autonomous vehicle 100 and the target object 20.

Next, the distance between the autonomous vehicle 100 and the target object 20 is compared with a reference distance (step S40).

In this case, when the distance between the autonomous vehicle 100 and the target object 20 is less than the reference distance, the autonomous vehicle 100 is decelerated or stopped (step S50).

Specifically, the speed of the autonomous vehicle 100 may be reduced based on the distance between the autonomous vehicle 100 and the target object 20 being less than a first reference distance. That is, the deceleration control signal is transmitted to the braking controller 102 based on the distance between the autonomous vehicle 100 and the target object 20 being less than the first reference distance.

In addition, the autonomous vehicle 100 may be stopped based on a distance between the autonomous vehicle 100 and the target object 20 being less than a second reference distance smaller than the first reference distance. That is, the braking control signal is transmitted to the braking controller 102 based on the distance between the autonomous vehicle 100 and the target object 20 being less than the second reference distance.

In addition, the speed of the autonomous vehicle 100 may be reduced or the autonomous vehicle 100 may be stopped in consideration of the moving direction and the relative speed of the target object 20, and the approach of the target object 20 to the autonomous vehicle 100.

For example, even if the distance between the autonomous vehicle 100 and the target object 20 is less than the first reference distance or the second reference distance, the speed of the autonomous vehicle 100 may not be reduced or may not stop when the autonomous vehicle 100 does not have a possibility of collision with the target object 20 in consideration of the moving direction and the relative speed of the target object 20, and the approach of the target object 20 to the autonomous vehicle 100.

On the other hand, when the distance between the autonomous vehicle 100 and the target object 20 is equal to or greater than the reference distance, the distance between the autonomous vehicle 100 and the target object 20 is calculated again (operation S30).

As such, the method of controlling the speed of the autonomous vehicle 100 according to the embodiment of the present disclosure determine the location of the target object 20 using the portable radar 200 mounted on the target object 20, and reduce the speed of the autonomous vehicle 100 or stop the autonomous vehicle 100 when the target object 20 is close to the autonomous vehicle 100, thereby overcoming the limitations of the sensor 104 mounted on the autonomous vehicle 100.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

1. A device for controlling a speed of an autonomous vehicle using a portable radar in a target object, the device comprising:
a receiver configured to receive radar information of the portable radar;
a processor configured to determine whether the target object is located in the vicinity of the autonomous vehicle based on the radar information; and
a controller configured to reduce a speed of the autonomous vehicle or stop the autonomous vehicle based on the target object being located in the vicinity of the autonomous vehicle.

2. The device of claim 1, wherein the radar information includes object information and location information of the target object.

3. The device of claim 2, wherein the processor is configured to calculate a distance between the autonomous vehicle and the target object based on the locations of the autonomous vehicle and the target object.

4. The device of claim 3, wherein the controller is configured to reduce the speed of the autonomous vehicle or stop the autonomous vehicle based on the distance between the autonomous vehicle and the target object being less than a reference distance.

5. The device of claim 4, wherein the processor is configured to vary the reference distance depending on an area in which the autonomous vehicle is located.

6. A system for controlling a speed of an autonomous vehicle using a portable radar in a target object, the system comprising:
a portable radar configured to transmit radar information;
a router configured to transmit the radar information received from the portable radar to the autonomous vehicle; and
a speed controller configured to determine whether the target object is located in the vicinity of the autonomous vehicle based on the radar information received from the router and reduce a speed of the autonomous vehicle or stop the autonomous vehicle based on the target object being located in the vicinity of the autonomous vehicle.

7. The system of claim 6, wherein the radar information includes object information and location information of the target object.

8. The system of claim 6, wherein the portable radar is configured to periodically transmits the radar information to the router.

9. The system of claim 6, wherein the router is configured to allocate to each of a plurality of areas and receive the radar information from the portable radar based on the location of the target object in the allocated area.

10. The system of claim 9, wherein the router is configured to share the radar information received from the portable radar with neighboring routers.

11. The system of claim 10, wherein the router is configured to transmit the radar information to the autonomous vehicle based on the location of the autonomous vehicle in the allocated area.

12. The system of claim 8, wherein the portable radar is configured to vary a transmission period of the radar information depending on an area in which the target object is located.

13. The system of claim 7, wherein the speed controller is configured to calculate a distance between the autonomous vehicle and the target object based on the locations of the autonomous vehicle and the target object.

14. The system of claim 13, wherein the speed controller is configured to reduce the speed of the autonomous vehicle or stop the autonomous vehicle based on the distance between the autonomous vehicle and the target object being less than a reference distance.

15. The system of claim 14, wherein the speed controller is configured to vary the reference distance depending on an area in which the autonomous vehicle is located.
